(19) United States
(12) Patent Application Publication
(10) Pub. No.: US 2016/0112592 A1
(43) Pub. Date: Apr. 21, 2016

(54) IMAGE FORMING APPARATUS AND CONTROLLING DEVICE

(71) Applicant: FUJI XEROX CO., LTD., Tokyo (JP)

(72) Inventors: Guodong WANG, Kanagawa (JP); Yusuke ONO, Kanagawa (JP)

(73) Assignee: FUJI XEROX CO., LTD., Tokyo (JP)

(21) Appl. No.: 14/695,770

(22) Filed: Apr. 24, 2015

(30) Foreign Application Priority Data
Oct. 17, 2014 (JP) 2014-212454

(51) Int. Cl. H04N 1/00; G06F 3/12

(52) U.S. Cl. CPC H04N 1/00896; G06F 3/1221; G06F 3/1203; G06F 3/1229

(57) ABSTRACT

An image forming apparatus includes an image forming portion that forms an image on a recording medium and a controller that switches an operation state of the image forming portion between a first power mode in which the image forming portion operates normally and a second power mode in which the image forming portion operates with lower power consumption than when the image forming portion operates in the first power mode. The controller changes, depending on a type of a control performed by a user on the apparatus, a transition period after which the operation state is switched from the first power mode to the second power mode.

### CROSS-REFERENCE TO RELATED APPLICATIONS

This application is based on and claims priority under 35 USC 119 from Japanese Patent Application No. 2014-212454 filed Oct. 17, 2014.

### BACKGROUND

(i) Technical Field

The present invention relates to image forming apparatuses and controlling devices.

(ii) Related Art

In order to reduce power consumption in an image forming apparatus for power-saving enhancement, the power mode of image forming portions of image forming apparatuses is controlled in some cases. An example of such a control is to switch the power mode from a first power mode, in which an image forming portion operates normally such as forming images on recording media, to a second power mode, in which the image forming portion operates with lower power consumption than when it operates in the first power mode for power saving.

### SUMMARY

According to an aspect of the invention, an image forming apparatus includes an image forming portion that forms an image on a recording medium and a controller that switches an operation state of the image forming portion between a first power mode in which the image forming portion operates normally and a second power mode in which the image forming portion operates with lower power consumption than when the image forming portion operates in the first power mode. The controller changes, depending on a type of a control performed by a user on the apparatus, a transition period after which the operation state is switched from the first power mode to the second power mode.

### BRIEF DESCRIPTION OF THE DRAWINGS

An exemplary embodiment of the present invention will be described in detail based on the following figures, wherein:

FIG. 1 illustrates a schematic configuration of an image forming apparatus according to an exemplary embodiment;

FIG. 2 is a block diagram of an example of a functional configuration of a central controller;

FIG. 3 is a flowchart illustrating an example of the operation of the central controller;

FIG. 4A illustrates the transition of the power mode of the image forming unit on which a user performs a local control and FIG. 4B illustrates the transition of the power mode of the image forming unit on which a user performs a remote control; and

FIG. 5 illustrates a screen for setting the local control and the remote control.

### DETAILED DESCRIPTION

Referring now to the drawings, an exemplary embodiment of the present invention is described in detail below.

### Description of Entire Image Forming Apparatus

Referring now to the drawings, an exemplary embodiment is described in detail below.

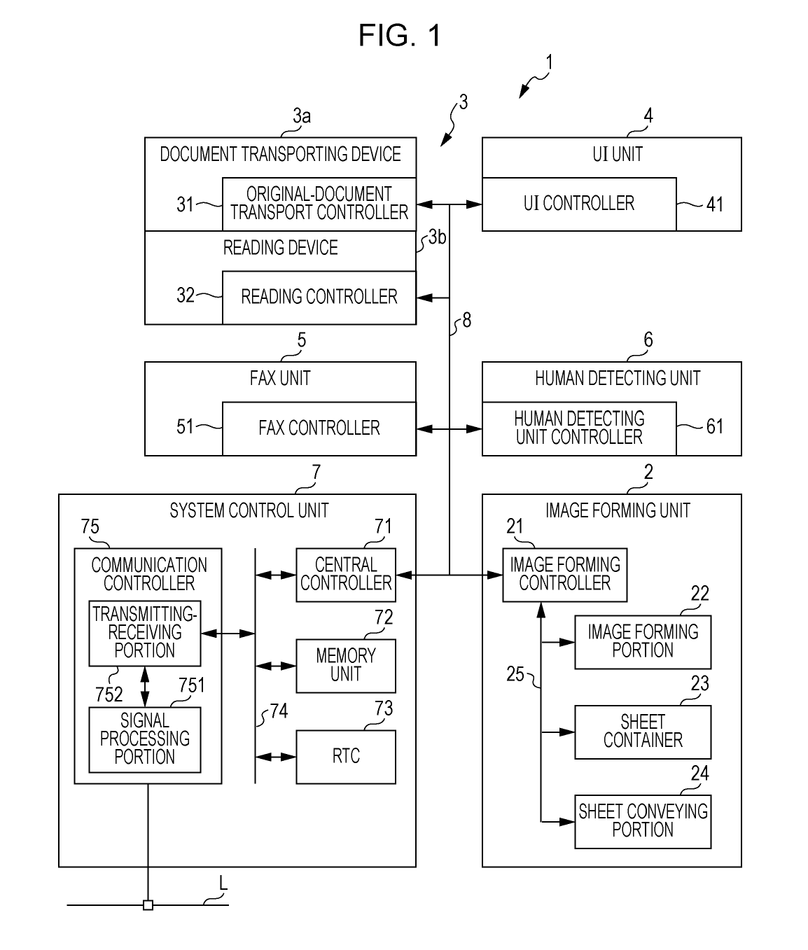

FIG. 1 illustrates a schematic configuration of an image forming apparatus 1 according to an exemplary embodiment.

The image forming apparatus 1 according to the exemplary embodiment includes an image forming unit 2, an image reading unit 3, a user interface (UI) unit 4, a fax unit 5, a human detecting unit 6, and a system control unit 7. The image forming unit 2 is an example of an image forming portion that forms images on paper sheets, which are examples of recording media, on the basis of image data of various different colors. The image reading unit 3 reads images on original documents. The user interface (UI) unit 4 receives control inputs from users and displays various types of information to users. The fax unit 5 transmits and receives data by fax through the communication line L. The human detecting unit 6 detects users of the image forming apparatus 1 in front of the image forming apparatus 1. The system control unit 7 controls the operations of the entire image forming apparatus 1, communications by the communication line L, and the like.

The image forming unit 2 is an example of a printing system that forms images on paper sheets. An example of the image forming unit 2 here is an electrophotographic printer.

The image forming unit 2 includes an image forming controller 21, an image forming portion 22, a sheet container 23, and a sheet conveying portion 24. The image forming controller 21, the image forming portion 22, the sheet container 23, and the sheet conveying portion 24 are connected together by an inter-unit communication line 25.

The image forming controller 21 controls the image forming portion 22, the sheet container 23, and the sheet conveying portion 24 when images are formed on paper sheets.

In the image forming portion 22, a photoconductor having, for example, a drum shape is charged with electricity and is then exposed to light controlled on the basis of image information so that an electrostatic latent image is formed on the photoconductor. Then, the electrostatic latent image is developed with toner by a developing device into a visible image. This toner image is then transferred to a paper sheet. The transferred image is fixed to the paper sheet by a fixing device with application of heat and pressure to form an image.

The sheet container 23 holds paper sheets waiting for images to be printed thereon. The sheet container 23 is, for example, a drawer unit disposed at a lower portion of the image forming apparatus 1 so as to be capable of being pulled out from the front side of the image forming apparatus 1. In order for a user to replenish paper sheets, the user pulls out the drawer unit and inserts paper sheets in the drawer unit. During image formation, the drawer unit is held in the image forming apparatus 1.

The sheet conveying portion 24 conveys paper sheets held in the sheet container 23 to the image forming portion 22. The sheet conveying portion 24 includes transport rollers, not illustrated, to transport paper sheets. The sheet conveying portion 24 also includes a registration roller, not illustrated, that temporarily stops rotating to stop transportation of a paper sheet and restarts rotating to feed the sheet at a predetermined time point after providing a registration adjustment to the sheet.

The image reading unit 3 is an image-information reading system that reads image information and specifically reads an image recorded on an original document. An example of the image reading unit 3 is a scanner.

The image reading unit 3 includes a reading device 3b, which transports image data to the image forming unit 2, and a document transporting device 3a, which picks up original documents from a stacked bundle one by one and transports the documents one after another to the reading device 3b.

The reading device 3b includes, for example, a light source that shines light on an original document, a line sensor that receives light reflected from the original document using multiple light receiving elements and generates image information, a reflex mirror that guides the light reflected from the original document to the line sensor, and an image-formation optical system that focuses the reflected light from the original document guided by the reflex mirror on the line sensor to form an image on the line sensor.

The reading device 3b also includes a reading controller 32. The reading controller 32 performs a predetermined process on the generated image information. The reading controller 32 also controls the operations of components in the reading device 3b during a reading operation.

An example of the document transporting device 3a is an auto document feeder (ADF). The document transporting device 3a includes, for example, an original-document receiving portion, on which a bundle of multiple original documents are placed, and an original-document ejection portion disposed below the original-document receiving portion and to which original documents that have finished being read are ejected in a stacked manner. The document transporting device 3a also includes sheet transport rollers, which pick up and transport original documents from the original-document receiving portion, and a separating mechanism, which separates paper sheets one from another using a feed roller or a retard roller.

The document transporting device 3a also includes an original-document transport controller 31. The original-document transport controller 31 controls the operations of components of the document transporting device 3a during the original-document transporting operation.

The UI unit 4 displays various types of information or receives control inputs from users. An example of the UI unit 4 is a touch panel. In this exemplary embodiment, a touch panel used as an example of the UI unit 4 is not limited to a particular one and may be of any type such as a resistive touch panel or a capacitive touch panel.

The UI unit 4 also includes a UI controller 41 that controls the operation of the UI unit 4.

The fax unit 5 has a facsimile function. Specifically, the fax unit 5 transmits, for example, image information read by the image reading unit 3. The fax unit 5 receives image information. On the basis of this image information, the image forming unit 2 prints an image on a paper sheet and outputs the image.

The fax unit 5 also includes a fax controller 51 that controls the operation of the fax unit 5.

The human detecting unit 6 includes a human detecting device, not illustrated, that detects the presence of a person (human body). Any human detecting device is usable as long as the device is capable of detecting the presence of a person. An example of the human detecting device is a pyroelectric sensor that uses a pyroelectric effect to detect entering of a person into a predetermined area by detecting infrared rays of specific wavelengths emanating from a person. Another example usable as the human detecting device is an infrared-ray reflection sensor that includes a light emitting element made of, for example, an infrared-ray emitting diode and a light receiving element that receives reflected light when the light emitted from the light emitting element is reflected off a person.

The human detecting unit 6 also includes a human detecting unit controller 61 that controls the operation of the human detecting unit 6.

The system control unit 7 includes a central controller 71, a communication controller 75, a memory unit 72, and a real time clock (RTC) 73. The central controller 71 is an example of a controller (controlling device) that controls the operation of the entire image forming apparatus 1. The communication controller 75 is connected to a communication line L formed of a network such as a local area network (LAN), a wide area network (WAN), or the Internet. The memory unit 72 stores, for example, various types of data that the image forming unit 2 uses for forming images. The real time clock (RTC) 73 measures the date and time. These units are connected together by an internal bus 74.

The communication controller 75 includes a transmitting-receiving portion 751, which is connected to the communication line L and transmits and receives signals to and from the communication line L, and a signal processing portion 752, which performs a predetermined process on transmitted and received signals. For example, the transmitting-receiving portion 751 receives a signal of a print job transmitted through the communication line L. Then, the transmitting-receiving portion 751 converts the received signal (print job) from an analog signal to a digital signal (packet) formed of data rows containing “0” and “1” and transmits the converted signal to the signal processing portion 752. The signal processing portion 752 determines whether the destination address of the packet received from the transmitting-receiving portion 751 coincides with address information (identification information) of the image forming apparatus 1 to which the signal processing portion 752 belongs, such as a medium access control (MAC) address. Then, the signal processing portion 752 transmits the packet (print job) that coincides with the MC address of the image forming apparatus 1 to which the signal processing portion 752 belongs to the central controller 71 through the internal bus 74. The central controller 71 also transmits the print job from the communication controller 75 to the image forming unit 2.

The central controller 71 of the system control unit 7 is connected by an inter-unit communication line 8 to the image forming controller 21, the original-document transport controller 31, the reading controller 32, the UI controller 41, the fax controller 51, and the human detecting unit controller 61. Thus, the central controller 71 controls the image forming controller 21, the original-document transport controller 31, the reading controller 32, the UI controller 41, the fax controller 51, and the human detecting unit controller 61 in the integrated manner so that these controllers operate organically, continuously, and integrally.

The communication line L is a communication device used for communicating information between the image forming apparatus 1 and other devices. Examples of the communication line L include a local area network (LAN) or a wide area network (WAN). The communication line L may be a public switched telephone network.

The system control unit 7 manages the power mode of the image forming unit 2, the image reading unit 3, the UI unit 4, the fax unit 5, and the human detecting unit 6.

Here, the power mode of the image forming unit 2 is switchable between a normal mode (first power mode) in which the image forming portion 22 operates normally and a power-saving mode (second power mode) in which the image forming portion 22 operates with lower power consumption than when it operates in the normal mode.

Here, in the normal mode, the above-described fixing device of the image forming portion 22 operates normally. Specifically, the fixing device fixes an image at a normal fixing temperature.

The power-saving mode according to the exemplary embodiment includes two types, a low-power mode and a sleep mode.

In the low-power mode, the temperature of the fixing device is set lower than that in the normal mode. In the sleep mode, the fixing device is turned off and the power supply to the fixing device is stopped.

In the low-power mode, the power consumption is reduced compared to that in the normal mode, whereby the image forming unit 2 is capable of saving power. Further in the sleep mode, the power consumption is further reduced compared to that in the low-power mode, whereby the image forming unit 2 is capable of further saving power.

Switching between the normal mode, the low-power mode, and the sleep mode is performed by the system control unit 7. More specifically, the central controller 71 of the system control unit 7 switches the operation state of the image forming portion 22 to any of the normal mode, the low-power mode, and the sleep mode in response to a user's instruction or in accordance with the operation state of each component of the image forming apparatus 1. Thus, the power mode of the image forming portion 22 is optimized to reduce the power consumption.

The way how the central controller 71 switches the power mode to any of the normal mode, the low-power mode, and the sleep mode usually includes two methods, a manual transition method and an automatic transition method.

In the manual transition method, the central controller 71 controls the power mode so that the power mode is switched from the normal mode to the low-power mode when a user presses a power-saving button, provided in the UI unit 4. In the manual transition method, the central controller 71 does not normally support transition from the low-power mode to the sleep mode.

The power mode is returned from the low-power mode to the normal mode in response to a user pressing the power-saving button again.

In the automatic transition method, a timer using a real time clock (RTC) 73 is used.

Specifically, a timer (low-power timer) is set for predetermined time to switch the power mode from the normal mode to the low-power mode. If there is no activity such as users' controls or reception of print jobs within the time for which the low-power timer is set in the normal mode, the low-power timer times out and the central controller 71 controls the power mode so that the power mode is switched from the normal mode to the low-power mode.

Here, examples of activities such as users' controls include users' specifying print settings on the UI unit 4, users' placing original documents on the original-document receiving portion of the document transporting device 3a, and users' inserting paper sheets in the drawer unit of the sheet container 23. Here, the activities are not limited to the cases where users control each component in the image forming apparatus 1 but also include the case where the human detecting device of the human detecting unit 6 detects users in front of the image forming apparatus 1.

In addition, a time (sleep timer) is set for predetermined time to switch the power mode from the low-power mode to the sleep mode. If there is no activity such as users' controls or reception of print jobs within the time for which the sleep time is set in the low-power mode, the sleep timer times out and the central controller 71 controls the power mode so that the power mode is switched from the normal mode to the sleep mode. The time for which the low-power timer is set and the time for which the sleep timer is set may be the same or different.

The power mode is returned from the low-power mode or the sleep mode to the normal mode in response to an activity such as users' controls or reception of print jobs.

In the above-described automatic transition method, however, the low-power timer or the sleep timer is set for uniform time. Thus, the normal mode is maintained until the low-power timer times out, whereby the power-saving effect is not sufficiently high.

To avoid such a disadvantage, the following control is conceivable, for example. After an activity such as a user's control is performed, the low-power timer is set so that the power mode is switched from the normal mode to the low-power mode in response to a timeout of the low-power timer. On the other hand, an example of conceivable control is that, when a print job is received, the power mode is immediately switched to the low-power mode after the completion of the print job without setting the low-power timer.

In this case, however, the power mode is immediately switched to the low-power mode after the completion of, for example, a print job even when a user who intends to use the image forming apparatus 1 is waiting in front of the image forming apparatus 1. Such a control is inconvenient for this user because it takes time for the image forming apparatus 1 to return from the low-power mode to the normal mode.

In order to address such a disadvantage, in this exemplary embodiment, the central controller 71 changes the transition period after which the power mode of the image forming portion 22 is switched from the first power mode for a normal operation to the second power mode depending on the types of user's controls performed on the image forming apparatus 1. This change of the transition period is described in detail below.

### Description of Central Controller

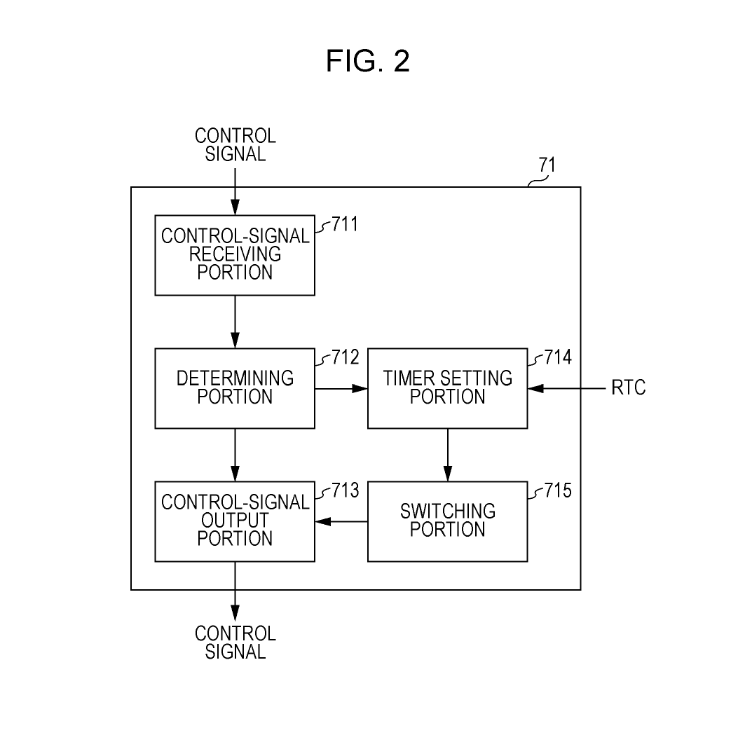

FIG. 2 is a block diagram of an example of the functional configuration of the central controller 71. In FIG. 2, however, some of the functions of the central controller 71 relating to the exemplary embodiment are selectively illustrated.

The central controller 71 illustrated includes a control-signal receiving portion 711, a determining portion 712, a control-signal output portion 713, a timer setting portion 714, and a switching portion 715.

The control-signal receiving portion 711 receives users' instructions or control signals relating to the operation states of the image forming unit 2, the image reading unit 3, the UI unit 4, the fax unit 5, or the human detecting unit 6 from each component.

Specifically, the control-signal receiving portion 711 receives, for example, information on the progress of a print job from the image forming controller 21 of the image forming unit 2 or information of completion of replenishment of sheet papers in the sheet container 23 from the image forming controller 21 of the image forming unit 2.

In addition, when, for example, a bundle of original documents are inserted in the ADF of the image reading unit 3, the control-signal receiving portion 711 receives from the original-document transport controller 31 a detection signal indicating the insertion of the bundle.

When, for example, the UI unit 4 acquires information on the setting items that a user specifies, the control-signal receiving portion 711 also receives this setting information from the UI controller 41.

The control-signal receiving portion 711 also receives information on, for example, the completion of facsimile transmission of the fax unit 5 from the fax controller 51. In addition, when, for example, the human detecting unit 6 detects a person, the control-signal receiving portion 711 receives from the human detecting unit controller 61 a detection signal indicating the detection of a person. Upon receipt of a signal such as a print job transmitted through the communication line L, the control-signal receiving portion 711 acquires from the communication controller 75 image data relating to the print job.

The determining portion 712 determines an operation that the image forming apparatus 1 is to perform on the basis of the received control signal. The control-signal output portion 713 outputs control signals to cause the image forming unit 2, the image reading unit 3, the UI unit 4, the fax unit 5, and the human detecting unit 6 to operate in accordance with the operation of the image forming apparatus 1 that the determining portion 712 has determined.

For example, when a user inserts a bundle of original documents into the ADF of the image reading unit 3 and inputs an instruction to photocopy these documents through the UI unit 4, the determining portion 712 determines to read the bundle of original documents inserted into the ADF and to form an image (perform photocopying) using the image forming unit 2 on the basis of the read image data. The control-signal output portion 713 then transmits control signals to the original-document transport controller 31 and the reading controller 32, the control signals indicating a command to pick up and read the bundle of original documents inserted into the ADF. The control-signal output portion 713 also transmits the read image data to the image forming controller 21 of the image forming unit 2 and transmits to the image forming controller 21 a control signal indicating a command to form an image on a paper sheet on the basis of the image data.

When a user inserts a bundle of original documents into the ADF of the image reading unit 3 and inputs an instruction to perform scanning through the UI unit 4, the determining portion 712 determines to read the bundle of original documents inserted into the ADF and to record (perform scanning) the read image data in the memory unit 72. The control-signal output portion 713 then transmits control signals to the original-document transport controller 31 and the reading controller 32, the control signals indicating a command to pick up and read the bundle of original documents inserted into the ADF. The control-signal output portion 713 then transmits the read image data to the memory unit 72 and stores the image data in the memory unit 72.

When a user inserts a bundle of original documents into the ADF of the image reading unit 3 and inputs an instruction to transmit them by facsimile through the UI unit 4, the determining portion 712 determines to read the bundle of original documents inserted into the ADF and to transmit (perform fax transmission of) the read image data from the fax unit 5. Thereafter, the control-signal output portion 713 transmits to the original-document transport controller 31 and the reading controller 32 control signals indicating a command to pick up and read the bundle of original documents inserted into the ADF. The control-signal output portion 713 then transmits the read image data to the fax controller 51 of the fax unit 5 and transmits to the destination specified by the user a control signal indicating that the image data is transmitted.

Upon receipt of a signal of a print job from the communication controller 75 through the communication line L from a device such as a personal computer (PC), the determining portion 712 determines to form (print) an image using the image forming unit 2 on the basis of image data of the print job. The control-signal output portion 713 then transmits image data received through the communication line L to the image forming controller 21 of the image forming unit 2 and transmits to the image forming controller 21 a control signal indicating a command to form an image on a paper sheet on the basis of image data.

Upon receipt of fax data from the communication controller 75 through the communication line L, the determining portion 712 determines to form an image (print the data received by fax) using the image forming unit 2 on the basis of fax data. The control-signal output portion 713 then transmits the fax data received through the communication line L to the image forming controller 21 or the fax controller 51 and transmits to the image forming controller 21 or the fax controller 51 a control signal indicating a command to form an image on a paper sheet on the basis of the fax data.

The timer setting portion 714 is an example of a setting portion and sets a timer used for controlling the power mode of the image forming unit 2.

In this exemplary embodiment, timers that the timer setting portion 714 sets include a remote timer besides the above-described low-power timer or sleep timer. The timer setting portion 714 sets any of the low-power timer, the remote timer, and the sleep timer in accordance with a control signal acquired by the control-signal receiving portion 711.

The low-power timer among these timers is a timer set when a user performs a local control on the image forming apparatus 1. Here, the local control is a direct control that a user normally located near the image forming apparatus 1 performs on the image forming apparatus 1.

Examples of the local control include an operation of a user replenishing paper sheets in the sheet container 23 of the image forming unit 2, an operation of a user inserting a bundle of original documents into the ADF of the image reading unit 3, and an operation of a user touching a touch panel or pressing buttons of the UI unit 4. The local control may include the human detecting device of the human detecting unit 6 detecting a user in front of the image forming apparatus 1, although the detection is not a control directly performed by a user on the image forming apparatus 1.

The low-power timer starts up every time when the user performs a local control on the image forming apparatus 1. The time for which the low-power timer is set is, for example, 1 minute to 60 minutes.

The remote timer is a timer set when a user performs a remote control on the image forming apparatus 1. Here, the remote control is an indirect control that a user normally located away from the image forming apparatus 1 performs on the image forming apparatus 1 through another device.

The remote control is performed through the communication line L. Examples of the remote controls include an operation of a user instructing printing using the image forming unit 2 of the image forming apparatus 1 through the communication line L from a personal computer (PC) and an operation of a user instructing facsimile transmission using the fax unit 5 of the image forming apparatus 1 similarly through the communication line L from a PC. The remote control also includes printing using the image forming unit 2 when data is received by fax through the communication line L.

The remote timer starts up every time when a user performs a remote control on the image forming apparatus 1. The time for which the remote timer is set is normally shorter than the time for which the low-power timer is set, for example, 5 seconds to 60 seconds.

The sleep timer is set when, as described above, the low-power timer times out and the power mode is switched to the sleep mode.

Although described in detail below, the low-power timer or the sleep timer are set when the remote timer times out and predetermined conditions are satisfied.

The switching portion 715 switches the operation state of the image forming portion 22 of the image forming unit 2 between the normal mode, which is the first power mode, and the low-power mode and the sleep mode, which are included in the second power mode.

### Description of Operation of Central Controller

Now, the operation of the central controller 71 having the above-described configuration is described.

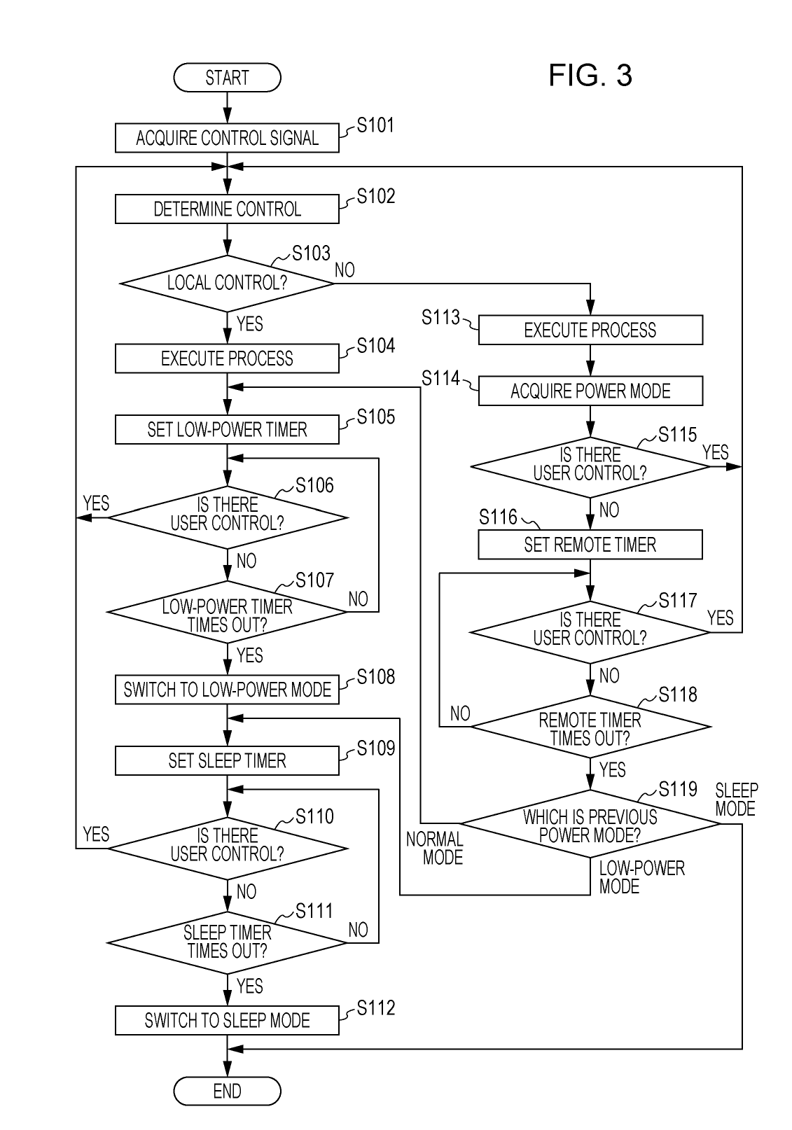

FIG. 3 is a flowchart illustrating an example of the operation of the central controller 71.

Firstly, the control-signal receiving portion 711 receives control signals regarding users' instruction or the operation states of the image forming unit 2, the image reading unit 3, the UI unit 4, the fax unit 5, or the human detecting unit 6 from these units (Step S101).

Subsequently, the determining portion 712 determines an operation to be performed on the image forming apparatus 1 on the basis of the received control signal (Step S102). The determining portion 712 also determines whether the control performed by a user at this time is a local control or a remote control, described above (Step S103).

If the control is a local control (Yes in Step S103), the control-signal output portion 713 outputs control signals to operate the image forming unit 2, the image reading unit 3, the UI unit 4, the fax unit 5, and the human detecting unit 6 on the basis of the operations of the image forming apparatus 1 determined by the determining portion 712. Then, a process instructed through the local control is performed (Step S104). At this time, the power mode of the image forming unit 2 is a normal mode. An example of the operation of the image forming apparatus 1 is printing using the image forming unit 2. In Step S104, a process such as printing is performed in some cases but not performed in other cases where the power mode of the image forming unit 2 is other than the normal mode. For example, a process such as printing is not performed and the processing moves to Step S105 in the following cases, for example, where a user replenishes paper sheets in the sheet container 23 of the image forming unit 2, where a user simply inserts a bundle of original documents in the ADF of the image reading unit 3, and where the human detecting unit 6 detects a user in front of the image forming apparatus 1.

When a process such as printing performed at the image forming apparatus 1 is finished, the timer setting portion 714 sets the low-power timer (Step S105). Whether the process performed at the image forming apparatus 1 is finished is capable of being determined by, for example, a control signal indicating the process completion that the control-signal receiving portion 711 receives from the image forming unit 2.

The timer setting portion 714 determines, on the basis of the control signal acquired by the control-signal receiving portion 711, whether a user has performed a local control or a remote control (Step S106).

If a local control or a remote control has been performed (Yes in Step S106), the processing returns to Step S102.

If a local control or a remote control has not been performed (No in Step S106), the timer setting portion 714 determines whether the low-power timer times out (Step S107).

If the low-power timer has not timed out (No in Step S107), the process flow returns to Step S106. If, on the other hand, the low-power timer has timed out (Yes in Step S107), the switching portion 715 switches the power mode of the image forming unit 2 from the normal mode to the low-power mode (Step S108).

After the power mode is switched to the low-power mode, the timer setting portion 714 sets the sleep timer (Step S109).

The timer setting portion 714 then determines again, on the basis of a control signal acquired by the control-signal receiving portion 711, whether a user has performed a local control or a remote control (Step S110).

If a local control or a remote control has been performed (Yes in Step S110), the process flow returns to Step S102.

If a local control or a remote control has not been performed (No in Step S110), the timer setting portion 714 determines whether the sleep timer has timed out (Step S111).

If the sleep timer has not timed out (No in Step S111), the process flow returns to Step S110. If, on the other hand, the sleep timer times out (Yes in Step S111), the switching portion 715 switches the power mode of the image forming unit 2 from the low-power mode to the sleep mode (Step S112).

If the user has performed a remote control not a local control (No in Step S103), a process instructed through the remote control is performed (Step S113). This process is, for example, printing using the image forming unit 2.

In this case, the timer setting portion 714 acquires the power mode of the image forming unit 2 in Step S101 from among the normal mode, the low-power mode, and the sleep mode (Step S114).

The timer setting portion 714 also determines whether a user has performed a local control or a remote control while the image forming apparatus 1 is performing a process such as printing (Step S115).

If a local control or a remote control has been performed (Yes in Step S115), the process flow returns to Step S102.

If, on the other hand, a local control or a remote control has not been performed (No in Step S115), the remote timer is set (Step S116).

Then, the timer setting portion 714 determines again, on the basis of a control signal acquired by the control-signal receiving portion 711, whether a user has performed a local control or a remote control (Step S117).

If a local control or a remote control has been performed (Yes in Step S117), the process flow returns to Step S102.

If a local control or a remote control has not been performed (No in Step S117), the timer setting portion 714 determines whether the remote timer has timed out (Step S118).

If the remote timer has not timed out (No in Step S118), the process flow returns to Step S117. If, on the other hand, the remote timer has timed out (Yes in Step S118), the switching portion 715 determines the power mode of the image forming unit 2 as the power mode acquired in Step S114 and switches the power mode to the power mode that the image forming unit 2 has been in before the remote control is performed (Step S119). Specifically, the power mode of the image forming unit 2 is changed to the normal mode, the low-power mode, or the sleep mode.

If the power mode of the image forming unit 2 is switched to the normal mode in Step S119, the process flow returns to Step S105, that is, the low-power timer is set. In this case, however, a period required after the remote timer is set in Step S116 until the power mode is switched to the low-power mode corresponds to the sum of time for which the remote timer is set and time for which the low-power timer is set. Thus, in this case, the timer setting portion 714 may perform setting such that a period required after the remote timer is set in Step S116 until the power mode is switched to the low-power mode corresponds to only time for which the low-power timer is to be set.

If the power mode of the image forming unit 2 is switched to the low-power mode in Step S119, the process flow returns to Step S109. Specifically, the sleep timer is set.

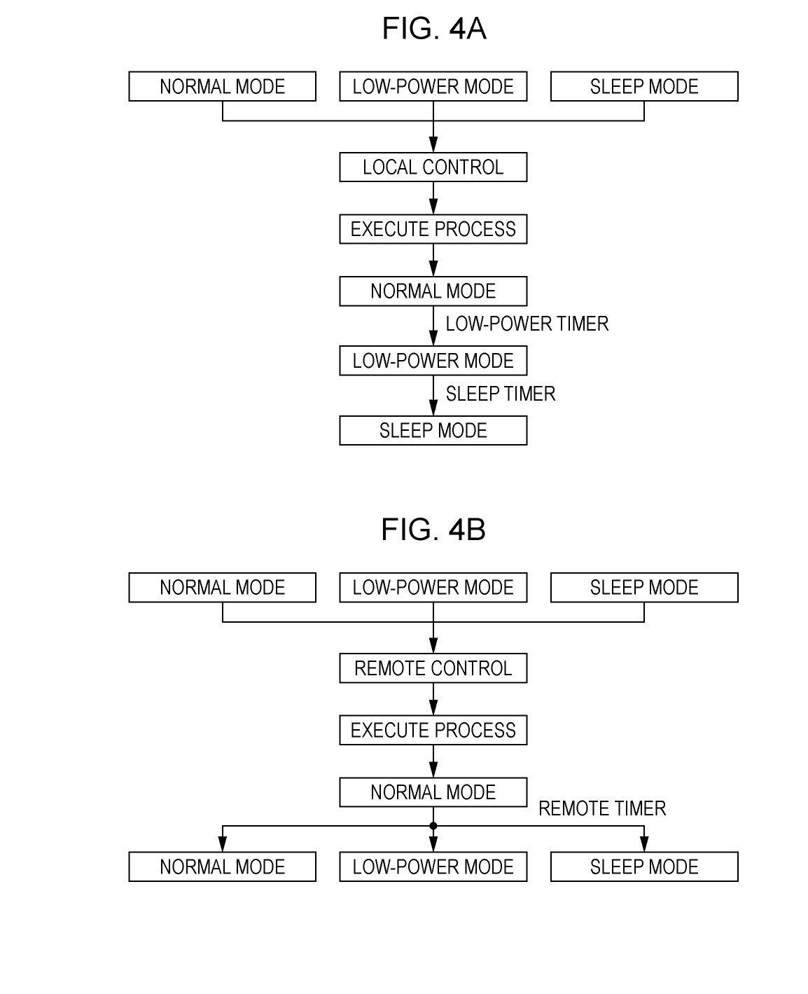

FIG. 4A illustrates the transition of the power mode of the image forming unit 2 when the control performed by a user in Step S101 is a local control. FIG. 4A corresponds to Step S104 to Step S112 illustrated in FIG. 3. FIG. 4B illustrates the transition of the power mode of the image forming unit 2 when the control performed by a user in Step S101 is a remote control. FIG. 4B corresponds to Step S113 to Step S119 illustrated in FIG. 3. FIGS. 4A and 4B illustrate the cases where a local control or a remote control is not additionally performed during the procedure.

As illustrated in FIG. 4A, before the local control is performed, the power mode of the image forming unit 2 is the normal mode, the low-power mode, or the sleep mode. After a process instructed through the local control is executed, the power mode is switched to the normal mode. The power mode of the image forming unit 2 is then changed to the low-power mode after the low-power timer times out and then to the sleep mode after the sleep timer times out.

As illustrated in FIG. 4B, before the remote control is performed, the power mode of the image forming unit 2 is the normal mode, the low-power mode, or the sleep mode. After a process instructed through the remote control is executed, the power mode is switched to the normal mode. The power mode of the image forming unit 2 then returns to the power mode that the image forming unit 2 has been in before the remote control is performed when the remote timer times out. Specifically, if the image forming unit 2 is in the normal mode before the remote control is performed, the power mode is switched to the normal mode.

If the image forming unit 2 is in the low-power mode before the remote control is performed, the power mode is switched to the low-power mode. If, on the other hand, the image forming unit 2 is in the sleep mode before the remote control is performed, the power mode is switched to the sleep mode. Specifically, after a transition period for which the remote timer is set in the remote control in which a user performs an indirect control on the image forming apparatus 1 has passed, the power mode is switched to the power mode that the image forming unit 2 has been in before the power mode is switched to the normal mode.

In this exemplary embodiment, as illustrated in FIG. 4A, the low-power timer is set in the local control. The low-power timer is set for a relatively long time, such as 1 minute to 60 minutes, as described above. When the low-power timer times out, the power mode is switched to the low-power mode.

In the local control, a user is located in front of the image forming apparatus 1. Thus, setting the low-power timer for an extremely short time would affect or impair the usability for a user who operates the image forming apparatus 1 in front of the image forming apparatus 1. Thus, in this exemplary embodiment, the low-power timer is set for a relatively long time for usability enhancement.

In this exemplary embodiment, the remote timer is set in the remote control, as illustrated in FIG. 4B. The remote timer is set for a shorter time than the time for which the low-power timer is set, such as 5 seconds to 60 seconds, as described above. Specifically, the transition period for which the remote timer is set in the remote control in which a user performs an indirect control on the image forming apparatus 1 is set shorter than the transition period for which the local timer is set in the local control in which a user performs a direct control on the image forming apparatus 1.

In the remote control, a user is not located in front of the image forming apparatus 1 and normally operates the image forming apparatus 1 at a position away from the image forming apparatus 1. Thus, the usability is less likely to be affected in the remote control than in the case of the local control. Thus, in this exemplary embodiment, the remote timer is set for a relatively short time for enhancement of the power-saving effect.

In the remote control, the power mode returns to the power mode before the remote control is performed after the remote timer times out. As described above, the usability is less likely to be affected in the remote control. Thus, switching the power mode to the low-power mode or the sleep mode in response to a timeout of the remote timer would be less likely to cause a problem. In this exemplary embodiment, this configuration also enhances the power-saving effect.

On the other hand, when a local control is performed during the execution of a process instructed through the remote control or during the operation of the remote timer as described in Step S115 or Step S117, the process flow returns to Step S102. Specifically, the power mode is not switched to the power-saving mode such as the low-power mode or the sleep mode. In this case, a user is located in front of the image forming apparatus 1 to operate the image forming apparatus 1. Switching the power mode to the power-saving mode after the completion of the remote control in a short time for which the remote timer is set would impair the usability. Thus, in this case, the process flow returns to Step S102 and then Yes is selected in Step S103, whereby the low-power timer is set for a relatively long time. The usability is enhanced in this manner.

Or in other words, when a user has performed a direct operation or a local control on the image forming apparatus 1 while the image forming portion 22 is forming an image in accordance with the remote control or an indirect operation performed by a user on the image forming apparatus 1, the timer setting portion 714 sets, as a transition period following the image forming operation, a transition period designed for the case where the user performs a local control on the image forming apparatus 1.

In still other words, when a user performs a direct control on the image forming apparatus 1 after the transition period is set in correspondence with the transition period designed for a remote control in which a user performs an indirect control on the image forming apparatus 1, the timer setting portion 714 changes the transition period to a transition period designed for a local control in which a user performs a direct control on the image forming apparatus 1.

This exemplary embodiment is applicable not only to photocopying or printing but also to fax transmission printing or fax reception printing.

This exemplary embodiment enhances both the usability and the power-saving effect in the above-described manner.

Whether the control performed by a user is a local control or a remote control is not uniformly determined. The control performed by a user may be changed by changing the setting. Specifically, setting of the transition period may be changed depending on types of the user's control.

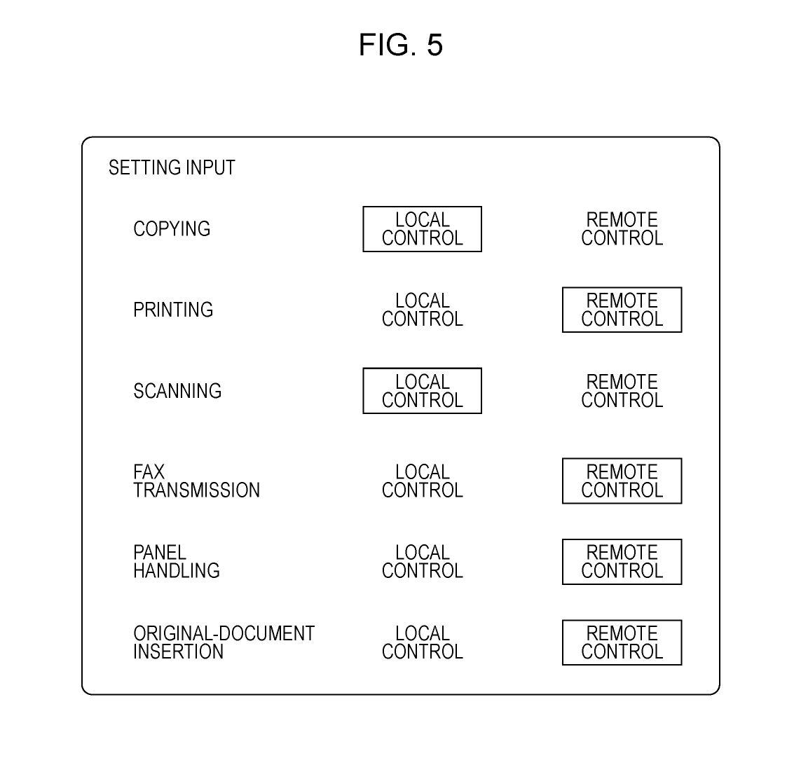

FIG. 5 illustrates a screen for setting the local control and the remote control.

The setting screen illustrated in FIG. 5 is displayed on, for example, a touch panel of the UI unit 4. In this example, a user is allowed to individually determine whether the control on photocopying, printing, scanning, fax transmission, panel handling (touch panel handling), or original-document insertion (insertion of original documents into the ADF) is performed through the local control or the remote control.

In FIG. 5, photocopying and scanning are determined as being performed through local controls whereas printing, fax transmission, panel handling, and original-document insertion are determined as being performed through remote controls. A user is allowed to perform setting by selecting the local control or the remote control through an operation such as touching the touch panel.

In the above-described example, the power-saving mode includes two types, the low-power mode and the sleep mode, but may include three types or more.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus, comprising:
an image forming portion that forms an image on a recording medium; and
a controller that switches an operation state of the image forming portion between a first power mode in which the image forming portion operates normally and a second power mode in which the image forming portion operates with lower power consumption than when the image forming portion operates in the first power mode,
wherein the controller changes, depending on a type of a control performed by a user on the apparatus, a transition period after which the operation state is switched from the first power mode to the second power mode.

2. The image forming apparatus according to claim 1, wherein the controller determines a transition period designed for a case where a user performs an indirect control on the apparatus to be shorter than a transition period designed for a case where a user performs a direct control on the apparatus.

3. The image forming apparatus according to claim 1, wherein the controller sets a transition period following the image formation if a user performs a direct control on the apparatus while the image forming portion is forming an image in response to a user performing an indirect control on the apparatus, the transition period being designed for a case where a user performs a direct control on the apparatus.

4. The image forming apparatus according to claim 1, wherein, if a user performs a direct control on the apparatus after a transition period designed for a case where a user performs an indirect control on the apparatus is set, the controller changes the transition period to a transition period designed for a case where a user performs a direct control on the apparatus.

5. The image forming apparatus according to claim 1, wherein the controller switches the operation state to an operation state before the operation state is switched to the first power mode in response to a timeout of a transition period designed for a case where a user performs an indirect control on the apparatus.

6. The image forming apparatus according to claim 1, wherein the controller is capable of changing the transition period depending on a type of a control performed by a user.

7. A controlling device, comprising:
a setting portion that changes, depending on a type of a control performed by a user on an apparatus, a transition period after which an operation state of an image forming portion, which forms an image on a recording medium, is switched from a first power mode in which the image forming portion operates normally to a second power mode in which the image forming portion operates with lower power consumption than when the image forming portion operates in the first power mode; and
a switching portion that switches the operation state of the image forming portion between the first power mode and the second power mode.
